(19) United States
(12) Patent Application Publication
(10) Pub. No.: US 2022/0196198 A1
(43) Pub. Date: Jun. 23, 2022

(54) A LINER ARRANGEMENT FOR INSTALLING IN A PIPE STRUCTURE, AND A METHOD FOR RELINING A PIPE STRUCTURE

(71) Applicant: REPIPER AB, Mölndal (SE)

(72) Inventor: Niklas NILSSON ALM, Bromma (SE)

(21) Appl. No.: 17/599,362

(22) PCT Filed: Mar. 24, 2020
(86) PCT No.: PCT/SE2020/050306

§ 371 Date: Sep. 28, 2021

(30) Foreign Application Priority Data
Mar. 28, 2019 (SE) 1950385-3

(51) Int. Cl. F16L 55/165; F16L 55/179

(52) U.S. Cl. CPC F16L 55/1654; F16L 55/1656; F16L 55/179

(57) ABSTRACT

The present disclosure relates to a liner arrangement for installing in a pipe structure, including at least one liner part configured for being inserted into the interior of the pipe structure and being shaped with smaller outer dimensions than the interior dimensions of the pipe structure The liner part is configured to cooperate with an inflatable bladder such that when the liner part and the inflatable bladder are located at the desired position and the bladder is inflated, the liner part will deploy or expand so that it conforms to the interior shape of the pipe structure. The liner arrangement furthermore includes a sealing arrangement extending along the circumference of the liner part and configured for sealing the liner arrangement against the interior of the pipe structure. The disclosure also relates to a method for relining a pipe structure.

### TECHNICAL FIELD

The invention relates to a liner arrangement for installing in a pipe structure, comprising at least one liner part configured for being inserted into the interior of said pipe structure and being shaped with smaller outer dimensions than the interior dimensions of the pipe structure. The liner part is further designed to cooperate with an inflatable bladder such that when the liner part and the inflatable bladder are located at the desired position and the bladder is inflated, the liner part is configured to deploy or expand so that it conforms to the interior shape of the pipe structure.

The invention also relates to a method for relining a pipe structure involving the steps of providing a liner arrangement for installing in said pipe structure and comprising at least one liner part; inserting said liner arrangement into the interior of said pipe structure, said liner arrangement being shaped with smaller outer dimensions than the interior dimensions of the pipe structure, and injecting air into the interior of said liner part so that it conforms to the interior shape of the pipe structure.

### BACKGROUND OF THE INVENTION

In the field of pipe structures, for example in the form of sewer systems for transporting fluids in houses, offices and other buildings, it is previously known that damaged and worn out sewage pipes and plumbing structures can be renovated by means of a relining process. During such a process, a pipe can be provided with a new internal liner material, instead of replacing the entire pipe, which is often costly and time-consuming. Such a relining process can be carried out in generally all types of buildings having a pipe structure for removing fluids and sewage to a sewer system or similar.

The relining process has many advantages as compared with the traditional process of replacing entire pipe structures, since no walls or floors need to be removed in order to access the pipe structure. Instead, the liner material is introduced into the interior of the pipe structure and is applied on the inside of the damaged pipes. The renovated pipe structure has a long lifetime and provides a high degree of sealing and strength.

As mentioned, the relining process relies on the use of an internal liner material, i.e. a material which is applied on the inner surface of the pipes which form the pipe structure.

More precisely, after cleaning of the interior surface of the pipe structure, the liner material, normally in the form of a thermosetting plastic material such as polyester, is applied by means of a nozzle device which is inserted into the pipe structure and which is configured for spraying the liner material onto the interior wall of the pipe structure as it moves along the pipe structure. After a certain time period, the liner material will cure and form an additional inner layer of the pipe structure.

A second method for relining a pipe structure is to introduce a tube-shaped, i.e. generally cylindrically shaped element, into the interior of the pipe structure, more precisely in a position which is aligned so that its position corresponds to a damage or a crack of the pipe structure. The cylindrical element is normally soaked in a thermosetting plastic material before it is introduced into the pipe structure. When the cylindrical element is in its correct position, it is inflated by means of pressurized air so that it is pressed against the interior surface of the pipe structure while the thermosetting material is allowed to cure. After a certain time period, the liner material which is held in the liner element has cured and has formed an additional inner layer inside the pipe structure.

A particular problem which must be solved in the above-mentioned methods for relining is that the tube-shaped lining element which is formed in the pipe structure must provide a tight sealing against the inner wall of the pipe structure. Otherwise, leakage may occur from the pipe structure.

A previously known method for providing a sealing for a relining arrangement is disclosed in the patent document U.S. Pat. No. 4,901,424. This arrangement is based on the use of a form which is inserted between the ends of a pipe and a lining before the lining is radially expanded. When the form is removed, a sealing ring is inserted into the space which is left by the removed form. The sealing ring will then be sealingly compressed.

U.S. Pat. No. 5,950,682 and US 2014/102 576 disclose T-shaped relining arrangements designed to fit into and repair a T-junction of a pipe. The relining arrangements are designed to cooperate with an inflatable bladder such that the relining arrangement will conform to the interior of the pipe junction when the bladder is inflated.

It should be noted that there is a demand for improved methods and arrangement for relining of existing pipe structures. In particular, there is a need for secure sealing arrangements which can be applied in a secure manner and at a low cost so that the lining material can be maintained inside the pipe structure without any risk for leakage or further damage. Consequently, there is a need for further improvements within the relevant field of technology.

### SUMMARY OF THE INVENTION

In accordance with the present disclosure, there is provided an improved liner arrangement having the purpose of solving the above-mentioned problems related to prior art within this field.

In accordance with the disclosure, this object is obtained by means of a liner arrangement for installing in a pipe structure, comprising at least one liner part configured for being inserted into the interior of said pipe structure and being shaped with smaller outer dimensions than the interior dimensions of the pipe structure. The liner part is further designed to cooperate with an expanding device, e.g. an inflatable bladder, such that when the liner part and the expandable device are located at the desired position and the expandable device is expanded, the liner part is configured to deploy or expand so that it conforms to the interior shape of the pipe structure. The liner arrangement furthermore comprises a sealing arrangement extending along the circumference of said liner part and configured for sealing the liner arrangement against the interior of the pipe structure. The liner arrangement is flexible, e.g. by being made from a material which may bend or wrinkle such as a felt, and intended to function as a carrier for a curable resin which, when cured, will form a liner portion of the pipe structure.

According to the disclosure, certain advantages are obtained. Firstly, an efficient process for installing a liner arrangement in a pipe structure is obtained. Furthermore, a secure sealing is obtained between the liner arrangement and the interior walls of the pipe structure, without any risk for leakage or further damage.

According to an embodiment, the sealing arrangement is pre-mounted on at least one end section of the liner part before positioning the liner arrangement in said pipe structure.

According to an embodiment, the sealing arrangement is made from neoprene rubber. However, any suitable elastic material may be used which may endure without being ruined for long term use, i.e. it shall last and maintain its sealing property for several years.

The dimensions of the sealing arrangement shall of course be selected such that its diameter corresponds to the diameter of the liner arrangement and the pipe into which the liner arrangement and the attached sealing arrangement shall be inserted. In general, the sealing arrangement is intended for pipes having an inner diameter of less than 20 cm, e.g. having a diameter from 4 to 16 cm.

The width of the sealing arrangement may also vary but is in general between 10 to 50 mm. Concerning the thickness of the material layer forming the seal it may suitably be between 1 and 10 mm, generally between 3 and 8 mm an in most cases having a thickness of between 4 and 7 mm. The sealing arrangement may be attached to the tubular liner parts by any suitable method, e.g. being stitched together by using a thread. The sealing arrangement preferably has the general shape of a circular band having an inside in contact with and facing towards the liner arrangement, an outside facing away from the liner arrangement and two lateral sides running along the circumference of the liner arrangement to which the sealing arrangement is attached. The sealing arrangement is preferably attached to the tubular liner parts only along one of its lateral sides so as to allow a thermosetting resin to be applied to the tubular liner parts under the sealing arrangement. In particular, the sealing arrangement could be attached to the tubular liner parts at intermittent zones or lines of attachment being spaced apart from each other along the circumference of the sealing arrangement in order to further increase the area to which a resin may be applied. For example, the sealing arrangement could be attached at 6 attachment zones spaced apart along a line following the circumference of the sealing arrangement.

The sealing arrangement may further be designed to have ridges and valleys running circumferentially around the sealing. In one embodiment, a first side, e.g. the inside, of the sealing arrangement is provided with the annular ridges and valleys while the other side, e.g. the outside, is planar. The valleys and ridges may for example form a corrugated, saw tooth or wave shaped pattern. Alternatively, there may be a multitude of ridges of any shapes separated from each other by valleys, having same or different width, as seen along the longitudinal axis of the tubular liner part. An advantage with the feature of having ridges and valleys provided on the sealing arrangement is that the sealing arrangement will be more bendable and flexible. For example, the valleys or grooves could help in making it easier to turn the tubular liner, to which the sealing arrangement is attached, inside out when desired, e.g. when the sealing arrangement is attached to a T-shaped liner arrangement (see below) in which the I-part is turned inside out. The provision of valleys and ridges could also improve the leak-proof properties of the sealing arrangement and provide a tighter seal between the ridges and the pipe wall than a flat sealing would provide.

According to an embodiment, the liner arrangement is generally T-shaped and comprises a first liner part which is connected to a second liner part, said liner arrangement being configured for being positioned inside a joint of said pipe structure.

The liner part is flexible and preferably made from a material which by itself is flexible such as a felt or the like which may be bent or wrinkled as the liner part is moved through a pipe system. When located at the desired position, the liner part will deploy or expand by an expanding device, e.g. an inflatable bladder, which cooperates with the liner part. According to an embodiment, said at least one liner part is manufactured from a polyester felt.

The liner part is adapted to be impregnated with a curable resin. The resin is normally a viscous paste when applied to the liner part in its uncured state but could be any kind of curable resin which serves to impregnate the liner part. Different kind of resin may be used which are curable by any suitable method, e.g. by heating or by UV. According to an embodiment, the liner part is impregnated with a thermosetting plastic configured for curing when positioned inside said pipe structure.

According to an embodiment, said liner part is generally tube-shaped.

Furthermore, the above-mentioned object of the disclosure is also obtained by means of a method for relining a pipe structure involving the steps of providing a liner arrangement for installing in said pipe structure and comprising at least one liner part; inserting said liner arrangement into the interior of said pipe structure, said liner arrangement being shaped with smaller outer dimensions than the interior dimensions of the pipe structure, and injecting air into an inflatable bladder such that when the liner part and the inflatable bladder is located at the desired position and the bladder is inflated, the liner part conforms to the interior shape of the pipe structure. The method also comprises sealing the liner arrangement against the interior of the pipe structure by means of a sealing arrangement extending along the circumference of said liner part.

Further advantages and advantageous features of the invention are disclosed in the following description and in the dependent claims.

### BRIEF DESCRIPTION OF THE DRAWINGS

The invention will be described in greater detail below with reference to the figures shown in the appended drawings.

FIG. 1 shows a simplified view of a building with a pipe structure of generally conventional type;

FIG. 2 shows a cut-out view of a joint arrangement in which a liner arrangement according to the disclosure is positioned; and

FIGS. 3a-3d shows a process for positioning the liner arrangement in a joint arrangement according to an embodiment.

### DESCRIPTION OF EMBODIMENTS

Different aspects of the present disclosure will now be described more fully with reference to the enclosed drawings. The embodiments disclosed herein can, however, be realized in many different forms and should not be construed as being limited to the aspects described below.

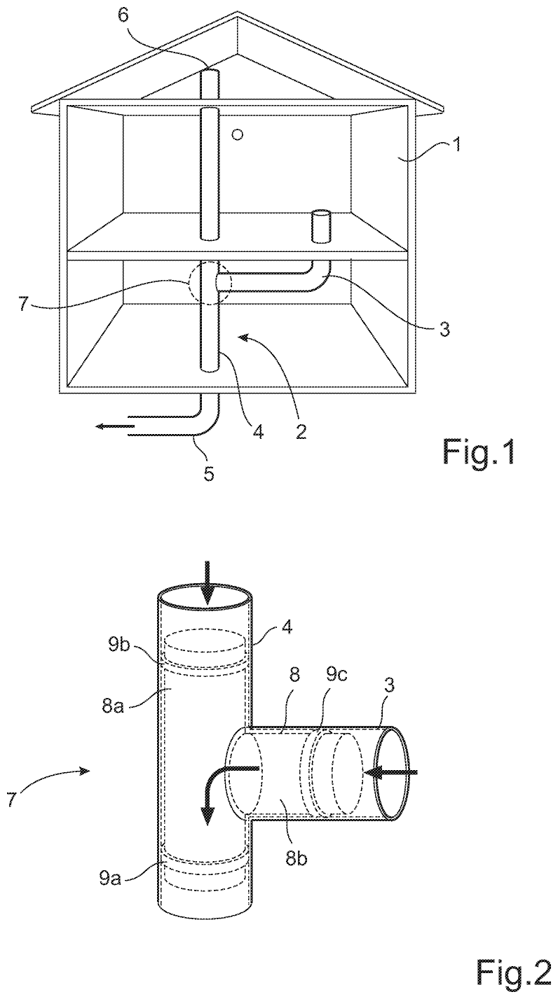

With initial reference to FIG. 1, there is shown a simplified view of a building 1 which is provided with pipe structure 2 of generally conventional type and used for transporting fluids and waste material which is intended to be guided away from the house 1. The pipe structure 2 can be adapted to be used, for example, in a domestic environment or in an office building and comprises a branch pipe 3 which can be used for transporting fluids from, for example, a kitchen, a bathroom or generally any type of equipment intended for guiding away fluids.

According to the embodiment shown in FIG. 1, the branch pipe 3 is connected to a main pipe 4 which in turn is connected to a main drain pipe 5 which guides the fluids in the pipe structure 2 further to a sewage network (not shown in detail in FIG. 1) in manner which is generally known as such.

FIG. 1 is drawn in a simplified manner and it is obvious that the pipe structure 2 may comprise a large number of branch pipes and other types of equipment which together form the entire pipe structure 2.

In the event that the pipe structure 2 needs to be repaired, for example due to cracks or broken parts of the pipes which form part of the pipe structure 2, it can be repaired by means of a relining process, which is a process which is generally known as such and which comprises a step of inserting a liner material into the pipe structure 2. Such a process can be carried out for example by inserting liner material at a suitable insertion point 6 of the pipe structure 2, as shown schematically in FIG. 1. By using a liner material in the form of a thermosetting plastic material, which is first inserted and then applied on the interior walls of the pipe structure 2, and which is then allowed to cure, the interior surface of a damaged pipe will be reinforced by the cured plastic material which consequently forms an additional wall structure inside the existing pipe.

The above-mentioned type of relining process is normally a quicker and less costly way to repair a faulty pipe structure than by replacing the pipe structure partly or in whole.

With reference to FIGS. 1 and 2, there is shown a joint 7 which is formed by the connection of the branch pipe 3 and the main pipe 4. The fluids in the branch pipe 3 are transported into the main pipe 4 and further to the main drain pipe 5, as shown by means of arrows in FIG. 2.

Joints where different pipes in a pipe structure are connected are often a cause of leakage and damage. For this reason, it is particularly important to be able to repair such joints by using liner material to create a seamless connection between the different pipes forming part of the joint. The joint 7 is indicated schematically in FIG. 1 and in an enlarged form in FIG. 2. According to the embodiment shown in FIG. 2, a particular liner arrangement 8 in the form of an inflatable bladder-like element is used. More precisely, the liner arrangement 8 is generally T-shaped with a first tube-shaped element in the form of a first liner part 8a which is connected to a further tube-shaped element in the form of a second liner part 8b. Both the first liner part 8a and the second liner part 8b are generally cylindrical, with outer dimensions which are slightly less than the inner dimensions of the pipe structure 2. Also, the first liner part 8a is intended to be positioned inside the main piper 4 whereas the second liner part 8b is intended to be positioned inside the branch pipe 3.

The process by means of which the liner arrangement 8 is positioned inside the joint will be described in greater detail below.

Furthermore, with reference to the embodiment shown in FIG. 2, the liner arrangement 8 comprises a sealing arrangement comprising three separate sealing elements 9a, 9b, 9c extending around the circumference of the ends of the first liner part 8a, 8b and the end of the second liner part 8c, respectively. Each sealing element 9a, 9b, 9c is configured for sealing an end portion of the liner arrangement 8 against the interior wall of the pipe structure 2. For this purpose, the sealing elements 9a, 9b, 9c are preferably manufactured from neoprene rubber, which is a synthetic rubber-like material which has suitable properties for use in environments such as the inside of fluid pipes. The sealing elements 9a, 9b, 9c are suitably mounted on the liner parts 8a, 8b before the liner arrangement 8 is introduced into the pipe structure 2.

In summary, the disclosure relates to a liner arrangement 8 which is intended to be installed in the pipe structure 2 and which comprises liner parts in the form of two generally tube-shaped elements 8a, 8b which are configured for being inserted into the interior of said pipe structure 2. The liner arrangement 8 is designed with smaller outer dimensions than the interior dimensions of the pipe structure 2. The embodiment shown in FIG. 2 comprises two tube-shaped elements 8a, 8b which correspond to the positions of the branch pipe 3 and the main pipe 4, respectively.

According to an alternative embodiment (not shown in the drawings), the liner arrangement can be formed as a cylinder, i.e. not T-shaped, in order to be positioned virtually anywhere along the pipe structure 2.

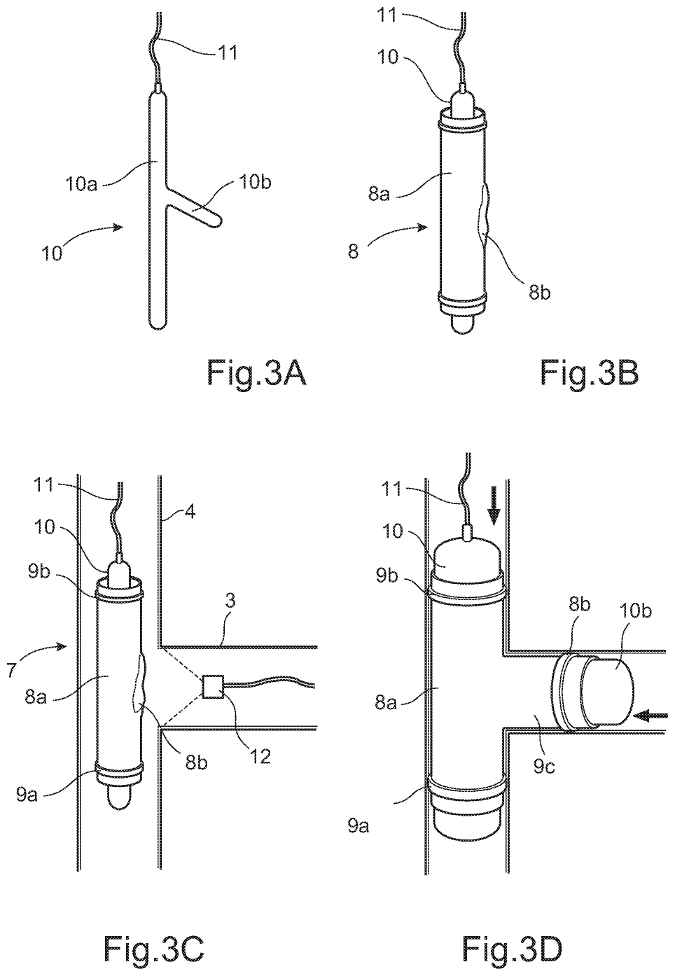

Also, it should be noted that the tube-shaped elements 8a, 8b are configured to cooperate with an inflatable bladder 10 (see FIG. 3a-d). The inflatable bladder 10 will be inflated when the tube shaped elements 8a, 8b are located at the desired position so that they may conform to the interior shape of the pipe structure 2. This process will now be described with reference to FIGS. 3a-d, in which FIG. 3a shows a separate inflatable bladder unit 10 which is configured to be connected to a supply of pressurized air via an air conduit 11. The bladder unit 10 comprises a main section 10a and a branch section 10b which together are arranged generally in a T-shaped configuration. FIG. 3a shows the bladder unit 10 in a condition before it is used for introducing the liner arrangement 8 into the pipe structure 2.

As shown in FIG. 3b, the bladder unit 10 can be inserted into the liner arrangement 8, i.e. in a configuration before the entire arrangement is inserted into the pipe structure 2. In particular, it should be noted that the second liner part 8b (see also FIG. 2) is suitably turned inside out and placed inside the first liner part 8a at this stage.

Before the liner arrangement 8 is introduced into the pipe structure 2, it is impregnated with a thermosetting plastic material which is adapted to be cured once the liner arrangement 8 is positioned in a correct position in the pipe structure 2.

FIG. 3c shows the arrangement with the bladder unit 10 and the liner arrangement 8 in a position inside the pipe structure 2 which is aligned with the joint 7 as also shown in FIG. 2. In order to position the bladder unit 10 and the liner arrangement 8 correctly with reference to the joint 7 and to the branch pipe 3, a camera unit 12 is used. For this purpose, the camera unit 12 is introduced in the branch pipe 3.

FIG. 3d show the arrangement with the bladder unit 10 and the liner arrangement 8 in a configuration in which the bladder unit 10 has been inflated by introducing pressurized air via the air conduit 11. This means that the bladder unit 10 will expand and force the first liner part 8a and the second liner part 8b into contact with the inner walls of the main pipe 4 and the branch pipe 3, respectively. Simultaneously, the sealing elements 9a, 9b, 9c will be sealingly pressed against the inner walls of the main pipe 4 and the branch pipe 3.

This means that any occurring gap between the outer periphery of the liner arrangement 8 and the inner walls of the pipe structure 2 will be sealed.

It should be noted that the sealing elements 8a, 8b, 8c are pre-mounted on the end sections of the first liner part 8a and the second liner part 8b before positioning the liner arrangement 8 in the pipe structure 2.

According to a further embodiment, only two sealing elements are used, i.e. a sealing element 9b between the upstream end of the first liner part 8a and the inside wall of the main pipe 4 and a further sealing element 9b between the upstream end of the second liner part 8b and the inside wall of the branch pipe 3. This is normally sufficient in the configuration according to FIG. 3d, since the two sealing elements 9b, 9c will be positioned where the flow of fluids reaches the liner arrangement (as indicated by means of arrows in FIG. 3d).

Furthermore, according to an embodiment, the sealing elements 9a, 9b, 9c are manufactured from neoprene rubber or a corresponding material. The sealing elements 9a, 9b, 9c are pre-mounted in a suitable manner, for example by means of adhesive or other fastening elements (not shown in detail in the drawings).

According to an embodiment the liner arrangement 8 is manufactured from a polyester felt. As mentioned, the liner arrangement 8 is impregnated with a curable thermosetting plastic material before it is introduced into the pipe structure 2 and positioned in a correct position. This means that the liner parts 8a, 8b will retain their expanded shape since the epoxy material will be hardened after a certain time period.

When the liner arrangement 8 has been positioned and the curable plastic material has been hardened, the bladder unit 10 can be deflated and then pulled out of the pipe structure 2.

The present disclosure also relates to a method for relining the above-mentioned pipe structure 2. The method involves a first step of providing a liner arrangement 8 for installing in the pipe structure 2, said liner arrangement 8 comprising at least one generally tube-shaped element, preferably the two tube-shaped elements 8a, 8b shown in FIG. 2. The method also comprises inserting the liner arrangement 8 into the interior of said pipe structure 2. According to the embodiment shown in FIGS. 3a-d, this process is accomplished by inserting the bladder unit 10 into the liner arrangement 8 before the complete arrangement is introduced into the pipe structure 2. In order to fit the liner arrangement 8 in the pipe structure 2, the liner arrangement 8 is shaped with smaller outer dimensions than the interior dimensions of the pipe structure 2.

Also, the method comprises a step of injecting air into the bladder unit 10, which in turn is positioned inside the interior of the liner arrangement 8. In this manner, the liner arrangement 8 will be forced to conform to the interior shape of the pipe structure 2.

Finally, the method comprises a step of sealing the liner arrangement 8 against the interior walls of the pipe structure 2 by means of a sealing arrangement 9a, 9b, 9c which extends along the circumference of the liner arrangement 8.

The invention is not limited to the embodiment but can be varied within the scope of the appended claims.

1. A liner arrangement for installing in a pipe structure,
comprising at least one liner part adapted to be impregnated with a curable resin, said liner part made to be flexible, and configured for being inserted into the interior of said pipe structure and being shaped with smaller outer dimensions than the interior dimensions of the pipe structure, said liner part is further designed to cooperate with an inflatable bladder such that when the liner part and the inflatable bladder is located at the desired position and the bladder is inflated, the liner part will deploy or expand to conform to the interior shape of the pipe structure, wherein said liner arrangement furthermore comprises a sealing arrangement extending along the circumference of said liner part and configured for sealing the liner arrangement against the interior of the pipe structure wherein the sealing arrangement has the general shape of a circular band having an inside in contact with and facing towards the liner arrangement, an outside facing away from the liner arrangement and two lateral sides running along the circumference of the liner arrangement to which the sealing arrangement is attached, the sealing arrangement further designed to have ridges and valleys running circumferentially around the sealing arrangement in order to facilitate the sealing arrangement to turn inside out during location and deployment of the liner arrangement.

2. The liner arrangement according to claim 1, wherein the sealing arrangement is pre-mounted on at least one end section of the liner part before positioning the liner arrangement in said pipe structure.

3. The liner arrangement according to claim 1, wherein the sealing arrangement is attached to the liner part only at one of the lateral sides of the sealing arrangement.

4. The liner arrangement according to claim 1, wherein the sealing arrangement is attached to the liner parts at intermittent attachment zones or attachment lines being spaced apart from each other along the circumference of the sealing arrangement.

5. The liner arrangement according to claim 1, wherein the sealing arrangement is attached to the tubular liner parts by being stitched together by a thread.

6. The liner arrangement according to claim 1, wherein said liner arrangement is generally T-shaped and comprises a first liner part which is connected to a second liner part, said liner arrangement being configured for being positioned inside a joint of said pipe structure.

7. (canceled)

8. The liner arrangement according to claim 1, wherein the sealing arrangement is designed to have a first side provided with said ridges and valleys while the second side is planar.

9. The liner arrangement according to claim 1, wherein said at least one liner part is manufactured from a polyester felt.

10. The liner arrangement according to claim 1, wherein said at least one liner part is impregnated with a thermosetting plastic configured for curing when positioned inside said pipe structure.

11. The liner arrangement to according to claim 1, wherein said at least one liner part is generally tube-shaped.

12. The liner arrangement according to claim 1, wherein said sealing arrangement is made from neoprene rubber.

13. A method for relining a pipe structure comprising:
providing a liner arrangement for installing in said pipe structure and comprising at least one liner part, said at least one liner part being flexible and impregnated with a curable resin;
inserting said liner arrangement into the interior of said pipe structure, said liner arrangement being shaped with smaller outer dimensions than the interior dimensions of the pipe structure, and
injecting air into an inflatable bladder designed to cooperate with the liner part such that, when the liner part and the inflatable bladder is located at the desired position and the bladder is inflated, the liner part conforms to the interior shape of the pipe structure, and
sealing the liner arrangement against the interior of the pipe structure by means of a sealing arrangement extending along the circumference of said liner part, said sealing arrangement having the general shape of a circular band having an inside in contact with and facing towards the liner arrangement, an outside facing away from the liner arrangement and two lateral sides running along the circumference of the liner arrangement to which the sealing arrangement is attached, the sealing arrangement further designed to have ridges and valleys running circumferentially around the sealing arrangement in order to facilitate the sealing arrangement to turn inside out during location and deployment of the liner arrangement.

14. The liner arrangement according to claim 2, wherein the sealing arrangement is attached to the liner part only at one of the lateral sides of the sealing arrangement.

15. The liner arrangement according to claim 2, wherein the sealing arrangement is attached to the liner parts at intermittent attachment zones or attachment lines being spaced apart from each other along the circumference of the sealing arrangement.

16. The liner arrangement according to claim 3, wherein the sealing arrangement is attached to the liner parts at intermittent attachment zones or attachment lines being spaced apart from each other along the circumference of the sealing arrangement.

17. The liner arrangement according to claim 2, wherein the sealing arrangement is attached to the tubular liner parts by being stitched together by a thread.

18. The liner arrangement according to claim 3, wherein the sealing arrangement is attached to the tubular liner parts by being stitched together by a thread.

19. The liner arrangement according to claim 4, wherein the sealing arrangement is attached to the tubular liner parts by being stitched together by a thread.

20. The liner arrangement according to claim 2, wherein said liner arrangement is generally T-shaped and comprises a first liner part which is connected to a second liner part, said liner arrangement being configured for being positioned inside a joint of said pipe structure.

21. The liner arrangement according to claim 3, wherein said liner arrangement is generally T-shaped and comprises a first liner part which is connected to a second liner part, said liner arrangement being configured for being positioned inside a joint of said pipe structure.
